(19) United States
(12) Patent Application Publication
(10) Pub. No.: US 2026/0098973 A1
(43) Pub. Date: Apr. 9, 2026

(54) DUAL SCINTILLATOR SYSTEM FOR NEUTRON AND ELECTROMAGNETIC IMAGING

(71) Applicant: SHINE Technologies, LLC, Janesville, WI (US)

(72) Inventors: Jonathan NIKOLEYCZIK, Janesville, WI (US); Benjamin JOHNSON, Janesville, WI (US); Gabriel BECERRA, Janesville, WI (US)

(21) Appl. No.: 19/113,074

(22) PCT Filed: Sep. 29, 2023
(86) PCT No.: PCT/US2023/034096

§ 371 Date: Mar. 19, 2025

Related U.S. Application Data
(60) Provisional application No. 63/412,128, filed on Sep. 30, 2022.

(51) Int. Cl. G01T 1/20; G01N 23/05; G01N 23/083; G01N 23/095; G01T 3/06; G02B 27/14

(52) U.S. Cl. CPC G01T 1/20181; G01N 23/05; G01N 23/083; G01N 23/095; G01T 1/20185; G01T 3/06; G01N 2223/505; G02B 27/141

(57) ABSTRACT

An imaging system that includes an imaging detector, an object region and a scintillator stack having a first scintillator and a second scintillator positioned between the imaging detector and the object region along an imaging pathway. The first scintillator is positioned upstream the second scintillator along the imaging pathway and is configured to convert a first ionizing radiation into first photons comprising a first wavelength and the second scintillator is configured to convert a second ionizing radiation into second photons comprising a second wavelength and comprises a higher transmittance percentage at the second wavelength than the first scintillator. WO

### CROSS-REFERENCE TO RELATED APPLICATIONS

This application claims the benefit of U.S. Provisional Application No. 63/412,128 filed on Sep. 30, 2022, which is incorporated herein by reference in its entirety.

### TECHNICAL FIELD

The present disclosure relates generally to the field of neutron, X-ray, and gamma ray imaging systems (e.g., radiography and tomography systems) and methods.

### BACKGROUND

Neutron radiography and tomography are proven techniques for the nondestructive testing and quality control of manufactured components in the aerospace, energy, automotive, defense, and other sectors. Like X-rays and gamma rays, when neutrons pass through an object, they provide information about the internal structure of that object. Neutrons are able to easily pass through many high-density materials and provide detailed information about internal materials, including many low-density materials. This property is important for a number of components that require nondestructive evaluation including jet engine turbine blades, munitions, aircraft and spacecraft components, and composite materials. Moreover, neutrons, X-rays, and gamma rays may be used to determine material properties of objects located in cargo containers and other visually obstructed locations.

Cargo containers (e.g., multi-transportation modality containers used to transport goods via ship, train, or truck, such as intermodal containers also known as shipping containers, sea cans or conex boxes) can present security risks because various unwanted materials can be placed in such containers and there are significant challenges associated with determining the exact contents of inbound containers at a port or other border entry. One of the primary challenges relates to the high number of such containers that arrive daily at busy ports and the need to quickly scan the containers so as not to unduly disrupt the flow of goods at such ports. The detection of special nuclear material (SNM) (i.e., fissile material) is of particular interest, but other unwanted materials may include explosives, drugs, and other contraband. Historically, commercial neutron radiography used nuclear reactors as the neutron source. Nuclear reactors are expensive, difficult to regulate, and are becoming increasingly more difficult to access, making this powerful inspection technique impractical for many commercial applications.

Accordingly, a need exists for improved x-ray, gamma ray, and neutron imaging methods and systems for both imaging and material identification purposes.

### SUMMARY

According to a first aspect of the present disclosure, an imaging system includes an imaging detector, an object region and a scintillator stack having a first scintillator and a second scintillator positioned between the imaging detector and the object region along an imaging pathway. The first scintillator is positioned upstream the second scintillator along the imaging pathway and is configured to convert a first ionizing radiation into first photons comprising a first wavelength and the second scintillator is configured to convert a second ionizing radiation into second photons comprising a second wavelength and comprises a higher transmittance percentage at the second wavelength than the first scintillator.

A second aspect includes the imaging system of the first aspect, wherein the first ionizing radiation comprises x-rays, gamma rays, or a combination of x-rays and gamma rays and the second ionizing radiation comprises neutrons.

A third aspect includes the imaging system of the second aspect, wherein the neutrons comprise thermal neutrons or fast neutrons.

A fourth aspect includes the imaging system of the first aspect, wherein the first ionizing radiation comprises neutrons and the second ionizing radiation comprises x-rays, gamma rays, or a combination of x-rays and gamma rays.

A fifth aspect includes the imaging system of the fourth aspect, wherein the neutrons comprise thermal neutrons or fast neutrons.

A sixth aspect includes the imaging system of any of the previous aspects, wherein the second scintillator comprises a transmittance percentage at the second wavelength that is at least 10% greater than the transmittance percentage of the first scintillator at the second wavelength.

A seventh aspect includes the imaging system of any of the previous aspects, wherein the first scintillator comprises a transmittance percentage of 25% or less at the second wavelength and the second scintillator comprises a transmittance percentage of 75% or more at the second wavelength.

An eighth aspect includes the imaging system of any of the previous aspects, wherein the first scintillator comprises a transmittance percentage of 15% or less at the second wavelength and the second scintillator comprises a transmittance percentage of 90% or more at the second wavelength.

A ninth aspect includes the imaging system of any of the previous aspects, wherein the first wavelength and the second wavelength differ by at least 10 nm.

A tenth aspect includes the imaging system of any of the previous aspects, wherein the first wavelength is in a range of from 520 nm to 565 nm and the second wavelength is in a range of from 435 nm to 500 nm.

An eleventh aspect includes the imaging system of any of the previous aspects, further including a radiation source configured to direct both the first ionizing radiation and the second ionizing radiation into the imaging pathway.

A twelfth aspect includes the imaging system of any of the previous aspects, further including a first radiation source configured to direct the first ionizing radiation into the imaging pathway and a second radiation source configured to direct the second ionizing radiation into the imaging pathway.

A thirteenth aspect includes the imaging system of any of the previous aspects, wherein the first scintillator is in direct contact with the second scintillator.

A fourteenth aspect includes the imaging system of any of the first through thirteenth aspects, wherein the first scintillator comprises a gadolinium oxide scintillator doped with terbium or europium.

A fifteenth aspect includes the imaging system of any of the first through thirteenth aspects, wherein the first scintillator comprises a zinc sulfide scintillator doped with copper.

A sixteenth aspect includes the imaging system of any of the first through thirteenth aspects, wherein the first scintillator comprises a cesium iodide scintillator doped with thallium.

A seventeenth aspect includes the imaging system of any of the first through thirteenth aspects, wherein the second scintillator comprises a polymer.

An eighteenth aspect includes the imaging system of the seventeenth aspect, wherein the second scintillator comprises polyvinyl toluene.

A nineteenth aspect includes the imaging system of any of the previous aspects, wherein the second scintillator is thicker than the first scintillator.

A twentieth aspect includes the imaging system of the nineteenth aspect, wherein a thickness ratio of the second scintillator to the first scintillator is 20:1 or greater.

A twenty-first aspect includes the imaging system of any of the previous aspects, further including an optical filter positioned along the imaging pathway between the scintillator stack and the imaging detector.

A twenty-second aspect includes the imaging system of the twenty-first aspect, wherein the optical filter is configured to selectively block the first photons or the second photons.

A twenty-third aspect includes the imaging system of the twenty-first aspect, wherein the imaging detector is a first imaging detector and the imaging system further includes a second imaging detector; and the optical filter comprises a dichroic mirror configured to permit transmission of the first photons through the dichroic mirror toward the first imaging detector and reflect the second photons toward the second imaging detector.

A twenty-fourth aspect includes the imaging system of any of the previous aspects, wherein the imaging detector comprises a color camera having two or more sets of detector sensor pixels and each set of detector sensor pixels is sensitive to a different wavelength range.

A twenty-fifth aspect includes the imaging system of the twenty-fourth aspect, wherein a first set of detector sensor pixels is sensitive to a first wavelength range and the first wavelength is within the first wavelength range and a second set of detector sensor pixels is sensitive to a second wavelength range and the second wavelength is within the second wavelength range.

A twenty-sixth aspect includes the imaging system of any of the previous aspects, further including a lens positioned along the imaging pathway between the scintillator stack and the imaging detector.

According to twenty-seventh aspect of the present disclosure, a method includes directing a first ionizing radiation through an object region onto a scintillator stack that includes a first scintillator and a second scintillator. The first scintillator is positioned upstream the second scintillator and a target object is positioned in the object region. The method further includes converting the first ionizing radiation into first photons comprising a first wavelength at the first scintillator, wherein the first photons propagate from the first scintillator, through the second scintillator, and toward an imaging detector, directing a second ionizing radiation through the object region onto the scintillator stack, and converting the second ionizing radiation into second photons comprising a second wavelength at the second scintillator, wherein the second photons propagate from the second scintillator toward the imaging detector and the second scintillator comprises a higher transmittance percentage at the second wavelength than the first scintillator.

A twenty-eighth aspect includes the method of the twenty-seventh aspect, wherein the first ionizing radiation comprises x-rays, gamma rays, or a combination of x-rays and gamma rays and the second ionizing radiation comprises neutrons.

A twenty-ninth aspect includes the method of the twenty-eighth aspect, wherein the neutrons comprise thermal neutrons or fast neutrons.

A thirtieth aspect includes the method of the twenty-seventh aspect, wherein the first ionizing radiation comprises neutrons and the second ionizing radiation comprises x-rays, gamma rays, or a combination of x-rays and gamma rays.

A thirty-first aspect includes the method of the thirtieth aspect, wherein the neutrons are thermal or fast neutrons.

A thirty-second aspect includes the method of any of the twenty-seventh through thirty-first aspects, wherein the second scintillator comprises a transmittance percentage at the second wavelength that is at least 10% greater than the transmittance percentage of the first scintillator at the second wavelength.

A thirty-third aspect includes the method of any of the twenty-seventh through thirty-second aspects, further including generating, using the imaging detector, one or more images of the target object based on the first photons and the second photons.

A thirty-fourth aspect includes the method of the thirty-third aspect, wherein the one or more images of the target object comprise a first image based on the first photons and a second image based on the second photons.

A thirty-fifth aspect includes the method of any of the twenty-seventh through thirty-fourth aspects, wherein the first wavelength and the second wavelength differ by at least 10 nm.

A thirty-sixth aspect includes the method of any of the twenty-seventh through thirty-fifth aspects, further including determining a first attenuation coefficient of the target object based on the first photons and a second attenuation coefficient of the second attenuation coefficient of the target object based on the second photons.

A thirty-seventh aspect includes the method of the thirty-sixth aspect, further including comparing the first attenuation coefficient and the second attenuation coefficient to determine one or more material properties of the target object.

A thirty-eighth aspect includes the method of the thirty-seventh aspect, wherein the target object comprises a cargo item positioned in a cargo container and the method further comprises determining a classification of the cargo item based on the one or more material properties.

A thirty-ninth aspect includes the method of the thirty-eighth aspect, wherein the classification of the cargo item provides an input for a quality control process, an illegal substance identification process, or a hazardous material identification process.

A fortieth aspect includes the method of any of the thirty-seventh through thirty-ninth aspects, wherein at least one of the one or more material properties is an approximate effective atomic number of the target object.

A forty-first aspect includes the method of any of the twenty-seventh through fortieth aspects, wherein the first scintillator comprises a doped gadolinium oxide scintillator and the second scintillator comprises a polymer.

A forty-second aspect includes the method of the forty-first aspect, wherein the doped gadolinium oxide scintillator is doped with terbium or europium and the second scintillator comprises polyvinyl toluene.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts one example embodiment of an imaging system comprising a radiation source, and object region, a scintillator stack, and an imaging detector, according to one or more embodiments shown and described herein; and

FIG. 2 schematically another example embodiment of an imaging system comprising a radiation source, and object region, a scintillator stack, and an imaging detector, according to one or more embodiments shown and described herein.

### DETAILED DESCRIPTION

Referring generally to the figures, embodiments of the present disclosure are directed to imaging systems configured to generate images and/or determine material properties of a target object using multiple types of ionizing radiation. For example, the imaging systems may generate both an X-ray image of the target object, as well as a neutron image of the target object using a single radiation source and a scintillator stack, providing an agile and multiuse imaging and testing system, particularly compared to the current non-destructive imaging systems. Similar to X-rays, when neutrons pass through an object, they provide information about the internal structure of that object. However, X-rays interact weakly with low atomic number elements (e.g., hydrogen) and strongly with high atomic number elements (e.g., many metals). Neutrons do not suffer from this limitation and can pass easily through high density metals and provide detailed information about internal materials, including low density materials. Thus, combining both X-ray and neutron radiography provides a more complete image of a target object and can provide robust material information about the target object. For example, the imaging system described herein may be used for the nondestructive testing of manufactured components in the aerospace, energy, automotive, defense, and other sectors for quality control or safety (detection of undesired/foreign substances/materials in object interior), as well as the inspection of cargo for contraband, and the inspection of packages for illicit/hazardous substances, and any other context in which a non-destructive identification or imaging is desired, particularly for objects that are not able to be visually inspected. Embodiments of imaging systems will now be described and, whenever possible, the same reference numerals will be used throughout the drawings to refer to the same or like parts.

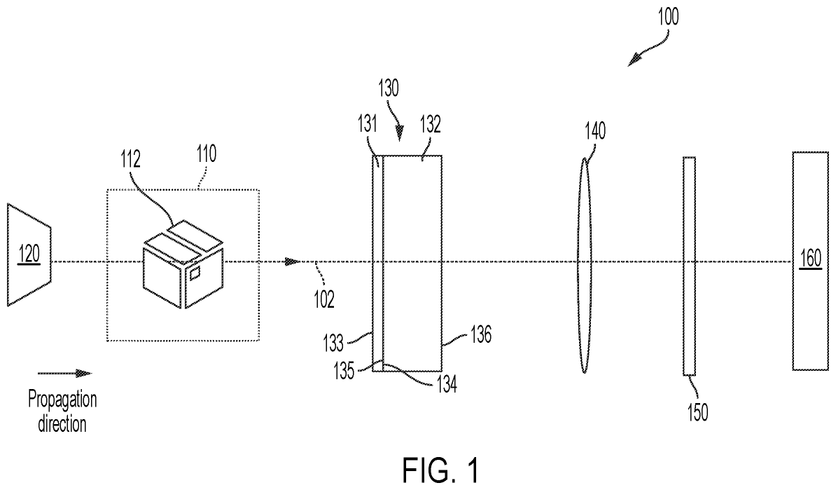

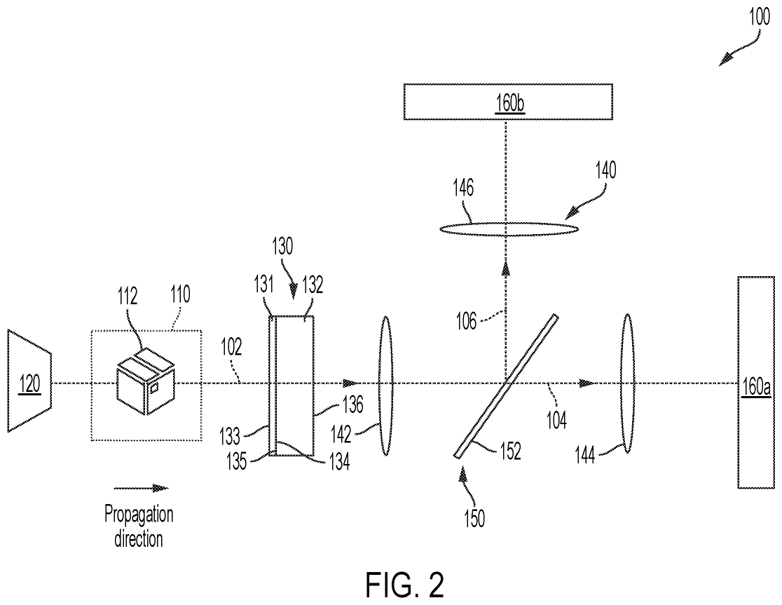

Referring now to FIGS. 1 and 2, an imaging system 100 is schematically depicted. The imaging system 100 comprises a radiation source 120, an imaging detector 160, and an imaging pathway 102 extending from the radiation source 120 to the imaging detector 160. The imaging pathway 102 is a pathway along which ionizing radiation and/or photons propagate. The imaging system 100 further comprises a scintillator stack 130 comprising a first scintillator 131 and a second scintillator 132. The scintillator stack 130 is positioned along the imaging pathway 102 between the radiation source 120 and the imaging detector 160. The radiation source 120 is configured to output ionizing radiation, such as x-rays, gamma rays, and neutrons, which may comprise thermal neutrons, epithermal neutrons, fast neutrons, or a combination thereof.

In operation, the ionizing radiation travels from the radiation source 120 through an object region 110 located along the imaging pathway 102. A target object 112 may be positioned in the object region 110. The target object 112 is an object of interest for imaging and/or analysis, such as material property analysis. At least a portion of the ionizing radiation traverses the object region 110 (e.g., the portion not blocked, reflected, absorbed, or otherwise obstructed by the target object 112) and reaches the scintillator stack 130. As described in more detail below, the scintillator stack 130 converts ionizing radiation into photons, which then propagate from the scintillator stack 130 to the imaging detector 160. The imaging detector 160 captures the photons output by the scintillator stack 130 to generate one or more images of the target object 112 and/or determine one or more material properties of the target object 112.

Referring still FIGS. 1 and 2, the first scintillator 131 is positioned upstream the second scintillator 132 along the imaging pathway 102. As used herein, “upstream” and “downstream” refer to the relative position of two locations or components along the imaging pathway 102 with respect to the radiation source 120. For example, a first component is upstream from a second component if the first component is closer to the radiation source 120 along the imaging pathway 102 traversed by the ionizing radiation and/or the photons than the second component. Because the first scintillator 131 is positioned upstream the second scintillator 132 along the imaging pathway 102, the ionizing radiation output by the radiation source 120 that reaches the second scintillator 132 first passes through the first scintillator 131. The first scintillator 131 comprises an input surface 133 and an output surface 135. The input surface 133 faces upstream along the imaging pathway 102 and receives ionizing radiation. The output surface 135 faces downstream along the imaging pathway 102 and outputs first photons. The second scintillator 132 comprises an input surface 134 and an output surface 136. The input surface 134 of the second scintillator 132 faces the output surface 135 of the first scintillator 131 and receives ionizing radiation. The output surface 136 faces downstream along the imaging pathway 102 and outputs second photons. In some embodiments, as depicted in FIGS. 1 and 2, the first scintillator 131 may be in direct contact with the second scintillator 132. This direct contact may increase the sharpness of the resultant images generated by the imaging detector 160. Alternatively, the first scintillator 131 may be spaced apart from the second scintillator 132 and, in some embodiments, one or more intervening optical components, such as lenses, collimators, or the like, may be positioned between the first scintillator 131 and the second scintillator 132.

The first scintillator 131 is configured to convert a first ionizing radiation into first photons comprising a first wavelength and the second scintillator 132 is configured to convert a second ionizing radiation into second photons comprising a second wavelength. The first ionizing radiation and the second ionizing radiation comprise types of radiation that have differing energy levels. In some embodiments, the first ionizing radiation (e.g., the radiation converted into first photons at the first scintillator 131) comprises x-rays, gamma rays, or a combination of x-rays and gamma rays and the second ionizing radiation (e.g., the radiation converted into second photons at the second scintillator 132) comprises neutrons, for example, fast neutrons, epithermal neutrons, or thermal neutrons. In other embodiments, the first ionizing radiation (e.g., the radiation converted to first photons at the first scintillator 131) comprises neutrons, for example, fast neutrons, epithermal neutrons, or thermal neutrons and the second ionizing radiation (e.g., the radiation converted to second photons at the second scintillator 132) comprises x-rays, gamma rays, or a combination of x-rays and gamma rays. Thus, the scintillator stack 130 facilitates radiography of using a combination of different types of ionizing radiation, such as X-ray and neutron radiation, to provide a more complete image of the target object 112 and provide robust material information about the target object 112. Moreover, and without intending to be limited by theory, it should be understood that both the first scintillator 131 and the second scintillator 132 have some sensitivity to both the first ionizing radiation and the second ionizing radiation but each are more sensitive to one of first and second ionizing radiation than the other.

The first scintillator 131 is opaquer to photons comprising the second wavelength than the second scintillator 132. In other words, the second scintillator 132 comprises a higher transmittance percentage at the second wavelength than the first scintillator 131. As used herein “transmittance percentage” refers to the percentage of initial intensity of a particular wavelength or wavelength range that passes through a material (e.g., the portion of the light that is not attenuated, reflected, absorbed, or otherwise obstructed by the material). Thus, because the first scintillator 131 is positioned upstream the second scintillator 132, the first scintillator 131 does not obstruct the second photons generated at the second scintillator 132, allowing both the first photons and the second photons to reach the imaging detector 160, facilitating both x-ray/gamma ray imaging and neutron imaging of the target object 112.

Indeed, the second scintillator 132 comprises a transmittance percentage at the second wavelength that is at least 5% greater than the transmittance percentage of the first scintillator at the second wavelength, for example, at least 10% greater, at least 15% greater, at least 20% greater, at least 25% greater, at least 30% greater, at least 35% greater, at least 40% greater, at least at least 45% greater, at least 50% greater, at least 55% greater, at least 60% greater, at least 65% greater, at least 70% greater, at least 75% greater, at least 85% greater, at least 90% greater, or a transmittance percentage difference in a range having any two of these values as endpoints. For example, in some embodiments, the first scintillator 131 comprises a transmittance percentage of 25% or less at the second wavelength, for example, 15% or less, and the second scintillator comprises a transmittance percentage of 75% or more at the second wavelength, for example, 90% or more. While it is desirable for the second scintillator 132 to have a high transmittance percentage at the second wavelength to minimize attenuation of the second photons, the methods described herein are still possible with low transmittance percentages at the second wavelength. In such a situation, post processing steps of the resultant images and other material information determined using the imaging detector 160 may be performed to clarify, amplify, or otherwise tune the results. Moreover, in some embodiments, the scintillation of first ionizing radiation into first photons occurs in the first scintillator 131 nearer the output surface 135 than the input surface 133 of the first scintillator 131 to minimize attenuation of the first photons in the first scintillator 131, which may also have some opaqueness to the first wavelength. For example, in some embodiments, the first scintillator 131 includes a support portion connected to a film portion, where the input surface 133 is a surface of the support portion, the output surface 135 is a surface of the film portion, and scintillation of first ionizing radiation into first photons occurs at the film portion.

In some embodiments, the first scintillator 131 comprises a doped gadolinium oxide scintillator, which may be doped with terbium, europium, praseodymium, calcium, cerium, strontium, or fluorine. In some embodiments, the first scintillator 131 comprises a doped zinc sulfide scintillator, which may be doped with copper. Other dopants that could be used in a doped zinc sulfide scintillator include antimony, magnesium, and manganese. In some embodiments, the first scintillator 131 comprises a doped cesium iodide scintillator, which may be doped with thallium or sodium. In some embodiments, the second scintillator 132 comprises a polymer, such as polyvinyl toluene (PVT), or comprises a liquid scintillator (which may be sealed in a container to form the surfaces of the scintillator). Without intending to be limited by theory, a doped zinc sulfide scintillator has a relatively low thermal neutron cross-section and is thus substantially non-reactive with thermal neutrons. In embodiments in which the second scintillator 132 generates thermal neutrons together with the second photons, which occurs when using a polymer scintillator, any of these thermal neutrons that travel back upstream and reach the doped zinc sulfide scintillator (e.g., the first scintillator 131), react minimally with the doped zinc sulfide scintillator, minimizing unwanted noise in the imaging system 100, particularly when compared to scintillators comprising a higher thermal neutron cross section.

As depicted in FIGS. 1 and 2, the second scintillator 132 may be thicker than the first scintillator 131. For example, a thickness ratio of the second scintillator to the first scintillator may be 5:1 or greater, 10:1 or greater, 15:1 or greater, 20:1 or greater, 25:1 or greater, 30:1 or greater, 35:1 or greater, 40:1 or greater, 50:1 or greater, 60:1 or greater, 75:1 or greater, or a thickness ratio in a range having any two of these values as endpoints. In other embodiments, the first scintillator 131 is thicker than the second scintillator 132. For example, a thickness ratio of the first scintillator to the second scintillator may be 5:1 or greater, 10:1 or greater, 15:1 or greater, 20:1 or greater, 25:1 or greater, 30:1 or greater, 35:1 or greater, 40:1 or greater, 50:1 or greater, 60:1 or greater, 75:1 or greater, or a thickness ratio in a range having any two of these values as endpoints. When the first scintillator 131 and the second scintillator 132 are different thicknesses, the first photons and the second photons have a differing brightness and sharpness, further providing distinguishing visual features between the resultant images of the target object 112 generated by the first and second photons. That is, additional distinguishing features beyond differing wavelengths. Indeed, without intending to be limited by theory, a thicker scintillator generates a resultant image that is brighter than the resultant image generated by a thinner scintillator, while a thinner scintillator generates a resultant image that is sharper than the resultant image generated by a thicker scintillator. Thus, the relative sizing of the first scintillator 131 and the second scintillator 132 can be tuned to generate a desired contrast in brightness and sharpness of the resultant images of the target object 112. While it may be desirable to use scintillators with differing thicknesses, it should be understood that yet other embodiments are contemplated in which the the first scintillator 131 and the second scintillator 132 have equal thicknesses. Indeed, in each of these embodiments, a benefit of the scintillator stack 130 is the total amount of first and second photons produced, which helps to generate images of the target object 112 with increased overall brightness, for example, when compared to images generated using a single scintillator system.

In some embodiments, the first wavelength (i.e., the wavelength of the first photons) differs from the second wavelength (i.e., the wavelength of the second photons) by at least 10 nm, for example, at least 15 nm, at least 25 nm, at least 50 nm, at least 75 nm, at least 100 nm, at least 125 nm, at least 150 nm, at least 200 nm, or may differ by a wavelength value in a range having any two of these values as endpoints. In some embodiments, the first wavelength is longer than the second wavelength and in other embodiments the first wavelength is shorter than the second wavelength. In some embodiments, the first wavelength is in a range of from 520 nm to 565 nm and the second wavelength is in a range of from 435 nm to 500 nm. It should be understood that the first and second wavelengths may comprise any wavelengths in the visible light spectrum.

Referring still to FIGS. 1 and 2, the radiation source 120 may comprise a single source generator configured to direct both the first ionizing radiation and the second ionizing radiation into the imaging pathway 102. In other embodiments, the radiation source 120 is a first radiation source and the imaging system 100 comprising at least one additional radiation source. In such embodiments, the first radiation source is configured to direct the first ionizing radiation (e.g., x-rays, gamma rays, or a combination thereof) and the second radiation source is configured to direct the second ionizing radiation (e.g., neutrons).

Referring still to FIGS. 1 and 2, the imaging system 100 may further comprise an optical filter 150 positioned between the imaging detector 160 and the scintillator stack 130. The optical filter 150 may comprise a filter wheel, an optical bandpass filter, a spectrometer, or any known or yet to be developed optical filter that is configured to selectively block the first photons and/or the second photons. In operation, the optical filter 150 may first selectively block the second photons such that the imaging detector 160 receives just the first photons and generates an image and/or determines material properties of the target object 112 based on the portion of the first ionizing radiation that is not obstructed by the target object 112. Next, the optical filter 150 may be altered to selectively block the first photons such that the imaging detector 160 receives just the second photons and generates an image and/or determines material properties of the target object 112 based on the portion of the second ionizing radiation that is not obstructed by the target object 112.

Referring now to FIG. 2, in some embodiments, the imaging detector is a first imaging detector 160a and the imaging system further comprises a second imaging detector 160b. In FIG. 2, the optical filter 150 is a dichroic mirror 152. The dichroic mirror 152 is configured to permit transmission of one or more ranges of wavelengths through the dichroic mirror 152 and reflect one or more other ranges of wavelength. For example, in some embodiments, the first photons pass through the dichroic mirror 152 and the second photons are reflected by the dichroic mirror 152 and in other embodiments, the first photons are reflected by the dichroic mirror 152 and the second photons pass through the dichroic mirror 152. Moreover, as shown in FIG. 2, the dichroic mirror 152 splits the imaging pathway 102 into a first pathway arm 104 and a second pathway arm 106. The first pathway arm 104 extends from the dichroic mirror 152 to the first imaging detector 160a and the second pathway arm 106 extends from the dichroic mirror 152 to the second imaging detector 160b.

In some embodiments, the imaging detector 160 comprises a color camera having two or more sets of detector sensor pixels, where each set of detector sensor pixels is sensitive to a different wavelength range. For example, the two or more sets of detector sensor pixels may include a first set of detector sensor pixels and a second set of detector sensor pixels. The first set of detector sensor pixels is sensitive to a first wavelength range which encompasses the wavelength of the first photons (i.e., the first wavelength). That is, the first wavelength is within the first wavelength range. The second set of detector sensor pixels is sensitive to a second wavelength range which encompasses the wavelength of the second photons (i.e., the second wavelength). That is, the second wavelength is within the second wavelength range. In this embodiment, the optical filter 150 may be removed because the imaging detector 160 itself differentiates the first photons and the second photons. Indeed, in embodiments comprising the optical filter 150, the imaging detector 160 may comprise a monochrome camera, where all pixels are equally sensitive to a broad range of wavelength. However, it should be understood that a color camera may be used as the imaging detector 160 in any of the embodiments of the imaging system 100 described herein.

Referring again to FIGS. 1 and 2, the imaging system may further comprise one or more lenses 140 and one or more mirrors positioned along the imaging pathway 102 between the scintillator stack 130 and the imaging detector 160. The one or more lenses 140 and the one or more mirrors may focus, direct, collimate, or otherwise alter the first photons and the second photons to facilitate imaging and analysis at the imaging detector 160. FIG. 2 depicts one example arrangement of lenses in which an objective lens 142 is positioned between the scintillator stack 130 and the dichroic mirror 152, a first tube lens 144 is positioned along the first pathway arm 104 of the imaging pathway 102 between the dichroic mirror 152 and the first imaging detector 160a and a second tube lens 146 is positioned along the second pathway arm 106 of the imaging pathway 102 between the dichroic mirror 152 and the second imaging detector 160b. While not depicted, in some embodiments the imaging system 100 may further comprise neutron focusing and/or reflecting elements positioned along the imaging pathway 102 between the radiation source 120 and scintillator stack 130.

Referring still to FIGS. 1 and 2, operation of the imaging system 100 will now be described. The imaging system 100 may be used in a variety of contexts to image and/or determine one or more material properties of the target object 112. For example, the imaging system 100 may be used to generate images of the target object based on different ionizing radiation. That is, generating an X-ray and/or gamma ray image of the target object, as well as a neutron image of the target object. Moreover, the imaging system 100 may be used to determine one or more material properties of the target object using different types of ionizing radiation. For example, the imaging system 100 may be used to determine x-ray, neutron, and gamma ray attenuation coefficients of the target object 112, which may be used to identify the target object 112.

One method of operating the imaging system 100 includes directing the first ionizing radiation from the radiation source 120, through the object region 110, and onto the scintillator stack 130. The first scintillator 131 of the scintillator stack 130 converts the first ionizing radiation into first photons having a first wavelength. Once converted, the first photons propagate from the first scintillator 131, through the second scintillator, and toward the imaging detector 160. The method also includes directing the second ionizing radiation from the radiation source 120, through the object region 110, and onto the scintillator stack 130. The second scintillator 132 of the scintillator stack 130 converts the second ionizing radiation into second photons comprising a second wavelength. Once converted, the second photons propagate from the first scintillator 131, through the second scintillator, and toward the imaging detector 160.

When the imaging system 100 is used for imaging, the method next comprises generating, using the imaging detector 160 (and one or more computing components communicatively coupled to the imaging detector 160), one or more images of the target object 112 based on the first photons and the second photons. For example, the method may include generating a first image (i.e., one of an X-ray/gamma ray image or a neutron image) of the target object 112 based on the first photons and generating a second image (i.e., the other of an X-ray/gamma ray image or a neutron image) of the target object 112 based on the second photons.

When the imaging system 100 is used for material property analysis, the method next comprises determining, using the imaging detector 160 (and one or more computing components communicatively coupled to the imaging detector 160), a first attenuation coefficient of the target object 112 based on the first photons and a second attenuation coefficient of the target object 112 based on the second photons. The first attenuation coefficient comprises one of an X-ray/gamma ray attenuation coefficient or a neutron attenuation coefficient and the second attenuation coefficient comprises the other of an X-ray/gamma ray attenuation coefficient or a neutron attenuation coefficient. The first attenuation coefficient and the second attenuation coefficient may be compared to determine one or more material properties of the target object 112, such as an approximate effective atomic number of the target object 112, which allows the imaging system 100 and/or a user of the imaging system 100 to identify the target object 112. For example, the target object 112 may comprise a cargo item positioned in a cargo container and the imaging system 100 may be used to determine a classification of the cargo item based on the one or more material properties. The classification of the cargo item may provide an input for a quality control process, an illegal substance identification process, or a hazardous material identification process. Indeed, some specific applications of the imaging system 100 include inspection of cargo for contraband, inspection of packages for illicit/hazardous substances, inspection of objects for quality control or safety (detection of undesired/foreign substances/materials in object interior), and any other context in which a non-destructive identification or imaging process is desired, particularly for obstructed object that are not able to be visually inspected.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

1. An imaging system comprising:
an imaging detector;
an object region; and
a scintillator stack comprising a first scintillator and a second scintillator positioned between the imaging detector and the object region along an imaging pathway, wherein:
the first scintillator is positioned upstream the second scintillator along the imaging pathway and is configured to convert a first ionizing radiation into first photons comprising a first wavelength; and
the second scintillator is configured to convert a second ionizing radiation into second photons comprising a second wavelength and comprises a higher transmittance percentage at the second wavelength than the first scintillator.

2. The imaging system of claim 1, wherein the first ionizing radiation comprises x-rays, gamma rays, or a combination of x-rays and gamma rays and the second ionizing radiation comprises neutrons.

3. The imaging system of claim 1, wherein the first ionizing radiation comprises neutrons and the second ionizing radiation comprises x-rays, gamma rays, or a combination of x-rays and gamma rays.

4. The imaging system of claim 1, wherein the second scintillator comprises a transmittance percentage at the second wavelength that is at least 10% greater than the transmittance percentage of the first scintillator at the second wavelength.

5. The imaging system of claim 1, wherein the first scintillator comprises a transmittance percentage of 15% or less at the second wavelength and the second scintillator comprises a transmittance percentage of 90% or more at the second wavelength.

6. The imaging system of claim 1, wherein the first wavelength and the second wavelength differ by at least 10 nm.

7. The imaging system of claim 1, wherein the first scintillator is in direct contact with the second scintillator.

8. The imaging system of claim 1, wherein the second scintillator is thicker than the first scintillator and a thickness ratio of the second scintillator to the first scintillator is 20:1 or greater.

9. The imaging system of claim 1, further comprising an optical filter positioned along the imaging pathway between the scintillator stack and the imaging detector, wherein the optical filter is configured to selectively block the first photons or the second photons.

10. The imaging system of claim 9, wherein:
the imaging detector is a first imaging detector and the imaging system further comprises a second imaging detector; and
the optical filter comprises a dichroic mirror configured to permit transmission of the first photons through the dichroic mirror toward the first imaging detector and reflect the second photons toward the second imaging detector.

11. The imaging system of claim 1, wherein:
the imaging detector comprises a color camera having two or more sets of detector sensor pixels and each set of detector sensor pixels is sensitive to a different wavelength range;
a first set of detector sensor pixels is sensitive to a first wavelength range and the first wavelength is within the first wavelength range; and
a second set of detector sensor pixels is sensitive to a second wavelength range and the second wavelength is within the second wavelength range.

12. The imaging system of claim 1, wherein the first scintillator comprises a zinc sulfide scintillator doped with copper.

13. A method comprising:
directing a first ionizing radiation through an object region onto a scintillator stack comprising a first scintillator and a second scintillator, wherein:
the first scintillator is positioned upstream the second scintillator; and
a target object is positioned in the object region;
converting the first ionizing radiation into first photons comprising a first wavelength at the first scintillator, wherein the first photons propagate from the first scintillator, through the second scintillator, and toward an imaging detector;
directing a second ionizing radiation through the object region onto the scintillator stack; and
converting the second ionizing radiation into second photons comprising a second wavelength at the second scintillator, wherein:
the second photons propagate from the second scintillator toward the imaging detector; and
the second scintillator comprises a higher transmittance percentage at the second wavelength than the first scintillator.

14. The method of claim 13, wherein the first ionizing radiation comprises x-rays, gamma rays, or a combination of x-rays and gamma rays and the second ionizing radiation comprises neutrons.

15. The method of claim 13, wherein the first ionizing radiation comprises neutrons and the second ionizing radiation comprises x-rays, gamma rays, or a combination of x-rays and gamma rays.

16. The method of claim 13, wherein the second scintillator comprises a transmittance percentage at the second wavelength that is at least 10% greater than the transmittance percentage of the first scintillator at the second wavelength.

17. The method of claim 13, further comprising generating, using the imaging detector, one or more images of the target object based on the first photons and the second photons, wherein the one or more images of the target object comprise a first image based on the first photons and a second image based on the second photons.

18. The method of claim 13, wherein the first wavelength and the second wavelength differ by at least 10 nm.

19. The method of claim 13, further comprising:
determining a first attenuation coefficient of the target object based on the first photons and a second attenuation coefficient of the target object based on the second photons; and
comparing the first attenuation coefficient and the second attenuation coefficient to determine one or more material properties of the target object.

20. The method of claim 19, wherein at least one of the one or more material properties is an approximate effective atomic number of the target object.
